(19) United States
(12) Patent Application Publication
(10) Pub. No.: US 2011/0090239 A1
(43) Pub. Date: Apr. 21, 2011

(54) NON-TRANSITORY COMPUTER-READABLE MEDIUM STORING DEVICE DRIVER

(75) Inventors: Hiroaki SUZUKI, Nagoya-shi (JP); Shohei ITO, Aichi-ken (JP)

(73) Assignee: BROTHER KOGYO KABUSHIKI KAISHA, Nagoya-shi (JP)

(21) Appl. No.: 12/976,817

(22) Filed: Dec. 22, 2010

Related U.S. Application Data
(63) Continuation-in-part of application No. PCT/JP2009/055732, filed on Mar. 24, 2009.

(30) Foreign Application Priority Data
Jun. 24, 2008 (JP) 2008-163938

(51) Int. Cl. G09G 5/02

(52) U.S. Cl. 345/589

(57) ABSTRACT

A non-transitory computer-readable medium storing a device driver, the device driver including a universal driver including instructions that cause a computer to perform the steps of acquiring graphic data and generating first image data based on the graphic data, a mini driver including a first resolution computed by multiplying a second resolution by an integer N not less than 2, a filtering processing module including the second resolution, a number of gray levels, and instructions that cause a computer to perform the steps of converting the first image data into second image data based on the second resolution and the number of gray levels, converting the first image data into third image data based on the number of gray levels and on a third resolution computed by dividing the first resolution by an integer M, and outputting the second and third image data to an image forming device.

### CROSS-REFERENCE TO RELATED APPLICATION

This application is a continuation-in-part of International Application No. PCT/JP2009/055732, filed Mar. 24, 2009, which claims priority from Japanese Patent Application No. 2008-163938, filed on Jun. 24, 2008. The disclosure of the foregoing applications is hereby incorporated by reference in its entirety.

### BACKGROUND

The present invention relates to a non-transitory computer-readable medium that stores a device driver that supplies image data for an image forming device to form an image.

As general-purpose operating systems (hereinafter called OS's) typified by Microsoft Windows (registered trademark) have become widespread in recent years, groups of subroutines called universal drivers have come to be provided along with the OS's. A universal driver is provided for each type of peripheral device (hereinafter simply called a device), such as a printer, a display, or the like, and is used in common among different devices. A processing portion that is unique to a device that is not supported by the universal driver is called a mini driver, and it is provided by the developer of the device, separately from the universal driver. For example, in a printing system that uses a universal driver, processing that reduces the size of a spool file of graphic data may be performed by a mini driver.

### SUMMARY

The universal driver itself supports only the parts of the processing that are shared by different devices. Specifically, the current situation is that the universal driver acquires graphic data that are created by an application program and simply generates image data that are matched to the resolution of an image forming device. Therefore, the universal driver is not capable of correcting a problem of diminished image quality that is specific to a low-resolution image forming device. Specifically, in a case where the image forming device has a low resolution, a problem occurs in that a diagonal line and a curved portion in the image take the form of a saw-toothed (jagged) stairstep pattern. The deterioration in the image quality is particularly noticeable in a case where the resolution is reduced for image data of a text that are generated from character codes. Furthermore, a case can be imagined in which a user wants to use the image forming device to perform the display or printing of an image using a number of pixels (hereinafter called a non-ordinary size) other than the number of pixels (hereinafter called an ordinary size) in the original image. Therefore, image data for the non-ordinary size may be generated separately and output to the image forming device together with image data for the ordinary size. However, if the same sort of processing is performed two times in order to output the same image in two sizes, a problem of reduced processing speed may arise.

Various exemplary embodiments of the general principles herein provide a non-transitory computer-readable medium that stores a device driver that, by utilizing a universal driver that is provided in a general-purpose operating system, can efficiently generate and output a plurality of sets of image data from which a high-quality image can be formed even by a low-resolution image forming device.

Exemplary embodiments provide a non-transitory computer-readable medium that stores a device driver. The device driver includes a universal driver, a mini driver, and a filtering processing module. The universal driver is provided by a general-purpose operating system and includes instructions that cause a computer to perform the steps of acquiring graphic data that serve as a basis for output image data for an image forming device to form an image and generating first image data based on the acquired graphic data. The mini driver includes, as a first resolution to be used when the first image data are generated, a resolution that is computed by multiplying a second resolution by an integer N that is not less than 2, the second resolution being a resolution that corresponds to an image that can be formed by the image forming device. The filtering processing module includes the second resolution, a number of gray levels that can be expressed by the image forming device, and instructions that cause a computer to perform the steps of converting the first image data that have been generated at the first resolution into second image data, based on the second resolution and the number of gray levels, converting the first image data that have been generated at the first resolution into third image data, based on the number of gray levels and on a third resolution that is computed by dividing the first resolution by an integer M, and outputting the second image data and the third image data that have been obtained through conversion as the output image data to the image forming device.

### BRIEF DESCRIPTION OF THE DRAWINGS

Exemplary embodiments will be described below in detail with reference to the accompanying drawings in which:

FIG. 1 is a block diagram that shows a configuration of a personal computer 1;

FIG. 2 is a processing flowchart that shows a flow of data output processing;

FIG. 3 is a flowchart of main processing of a device driver 210;

FIG. 4 is an explanatory figure that shows relationships of sizes (numbers of pixels) of various types of image data that are generated by the device driver 210;

FIG. 5 is an explanatory figure that shows a flow of processing that converts intermediate image data 31 into final image data 32 of a size for an ordinary display;

FIG. 6 is an explanatory figure that shows a flow of processing that converts the intermediate image data 31 into final image data 33 of a size for an enlarged display;

FIG. 7 is an explanatory figure that shows a case in which an image of an ordinary size is displayed on a display terminal 2;

FIG. 8 is an explanatory figure that shows a case in which an image of enlarged size is displayed on the display terminal 2;

FIG. 9 is an explanatory figure of image data that have been generated by ordinary rendering processing using a universal driver 211;

FIG. 10 is an explanatory figure of intermediate image data that have been generated by processing in an embodiment; and

FIG. 11 is an explanatory figure of final image data of a size for an ordinary display that have been generated by processing in the embodiment.

### DETAILED DESCRIPTION

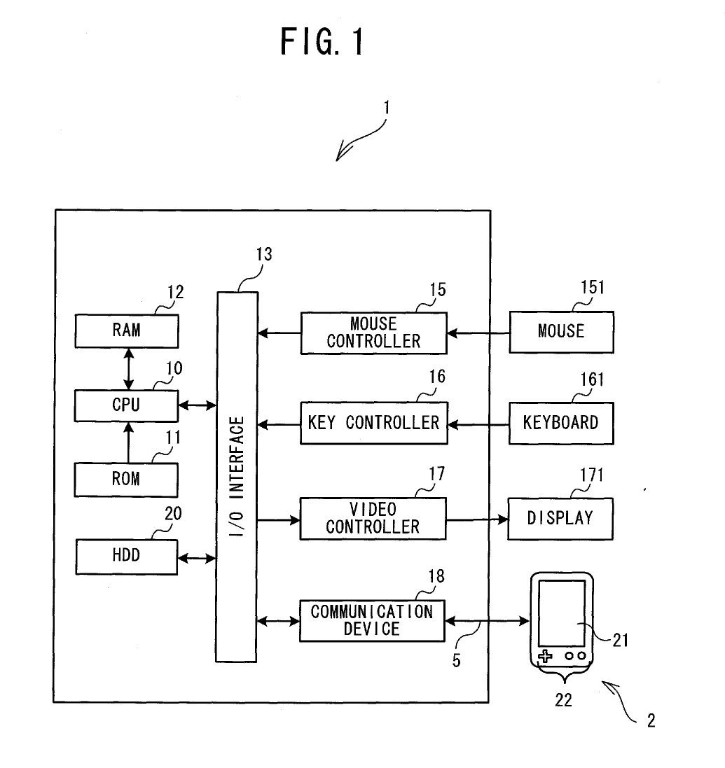

Hereinafter, an embodiment of the present invention will be explained with reference to FIGS. 1 to 11. Note that the referenced drawings are used to explain technological features that can be used in the present invention. Device configurations, flowcharts of various types of processing, and the like that are shown in the drawings are merely explanatory examples.

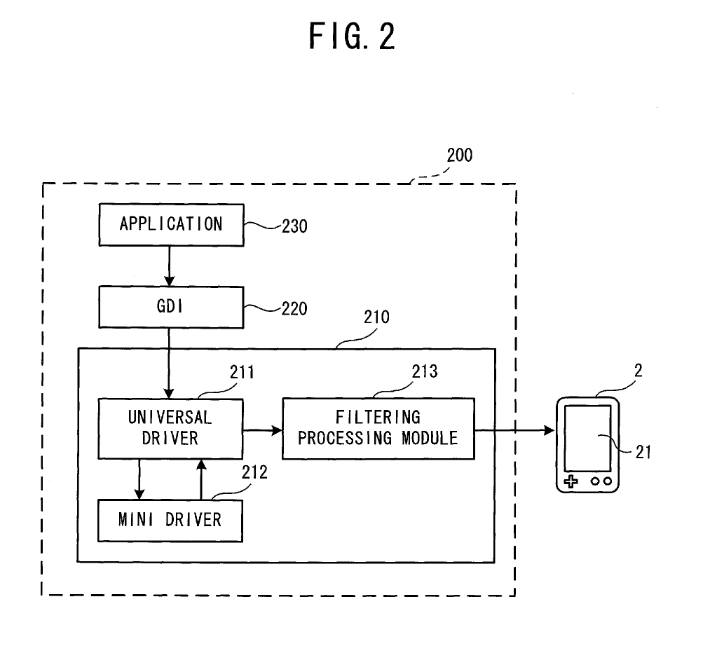

First, a configuration of a personal computer (hereinafter called a PC) 1 in which a device driver 210 is installed and an overview of a flow of processing in the PC 1 that outputs data to a display terminal 2 will be explained with reference to FIGS. 1 and 2.

The PC 1 is a known personal computer and is a general-purpose device. As shown in FIG. 1, the PC 1 includes a CPU 10 that performs control of the PC 1. A ROM 11 that stores a BIOS and the like and a RAM 12 that temporarily stores various types of data are connected to the CPU 10. An input/output (I/O) interface 13 that performs mediation of data transfers is also connected to the CPU 10. A mouse controller 15, a key controller 16, a video controller 17, a communication device 18, and a hard disk device (hereinafter called the HDD) 20 are connected to the I/O interface 13.

A mouse 151 is connected to the mouse controller 15 and is controlled by the mouse controller 15. A keyboard 161 is connected to the key controller 16 and is controlled by the key controller 16. A display 171 is connected to the video controller 17 and is controlled by the video controller 17.

The communication device 18 is connected to a LAN 5, and the PC 1 can perform communications with external devices such as the display terminal 2 and the like through the communication device 18. Note that the method for connecting the PC 1 and the display terminal 2 may also be a method other than the LAN 5, such as a USB cable or the like, and may be either one of wired and wireless. The display terminal 2 that can be connected to the PC 1 through the communication device 18 and the LAN 5 is a portable terminal device that has a display screen 21 and a plurality of operation keys 22. By operating the operation keys 22, a user of the display terminal 2 can display and view an image on the display screen 21 based on image data that are transmitted from the PC 1. In the present embodiment, the display terminal 2 that is connected to the PC 1 has a resolution of 100 dots per inch (dpi) and is capable of displaying four gray levels. The number of pixels from which the display screen 21 is configured are 1,188 in the vertical direction and 840 in the horizontal direction.

As shown in FIG. 2, a general-purpose OS 200, the device driver 210, which will be described later, a graphic device interface (GDI) 220, various types of application software (hereinafter simply called applications) 230 for generating text, computing numerical values, and the like, and the like are installed in the HDD 20. The GDI 220 controls image processing for image forming devices that are connected to the PC 1, such as a printer, the display terminal 2, and the like. Microsoft Windows (registered trademark), for example, can be used as the OS 200. The device driver 210, the GDI 220, and the applications 230 all operate on the OS 200.

As shown in FIG. 2, the device driver 210 includes a universal driver 211, a mini driver 212, and a filtering processing module 213. The universal driver 211 is provided together with the GDI 220 as a standard sub-system of the OS 200 and controls processing that is common to various types of output devices. For example, the universal driver 211 may cause the CPU 10 to perform processing that takes data that are created by any one of the applications 230 and converts the data to raster image data of a form that can be received by the display terminal 2 and displayed on the display screen 21.

The mini driver 212 and the filtering processing module 213 are created by the developer of the display terminal 2 and are provided together with, or separately from the OS 200. The mini driver 212 is a general printer description (GPD) file that contains setting information, such as an output size, a resolution, a number of gray levels, and the like, that is required when the universal driver 211 generates the raster image data. The filtering processing module 213 is a module that generates final raster image data by converting the resolution and converting the gray levels of the raster image data that have been generated by the universal driver 211 in the CPU 10, and then outputs the final raster image data to the display terminal 2. In the explanation that follows, the raster image data that have been generated by the universal driver 211 are called intermediate image data. The raster image data that are generated by the filtering processing module 213 based on the intermediate image data are called final image data.

Next, the overview of the flow of the processing in the PC 1 that outputs the data to the display terminal 2 will be explained with reference to FIG. 2 (details will be explained later). First, when a request for output to the display terminal 2 is made in any one of the applications 230, the GDI 220 interprets the request as a command from the application 230 and dynamically links to the universal driver 211. The GDI 220 causes the intermediate image data to be generated in the universal driver 211 from data that are created by the application 230

At this time, the universal driver 211 refers to the setting information in the mini driver 212 and generates the intermediate image data based on the setting information. Ordinarily, the resolution that the mini driver 212 contains as the setting information is the actual resolution of the display terminal 2. In the present embodiment, however, a resolution that is higher than the resolution of the display terminal 2 has been set in the mini driver 212. Accordingly, the intermediate image data that are generated by the universal driver 211 have a resolution that is higher than the resolution of the display terminal 2, that is, the intermediate image data size is greater (the intermediate image data includes a greater number of pixels) than the size of the display screen 21.

Thereafter, the intermediate image data are converted by the filtering processing module 213 into the final image data for an ordinary display size that matches the resolution of the display terminal 2 and the final image data for an enlarged display size that is larger than the ordinary display size. The final image data with the two different sizes can then be output to the display terminal 2 and can be displayed on the display screen 21. Although it has been omitted from FIG. 2, a spool file that temporarily stores the data before output may also be provided between the GDI 220 and the device driver 210 or at a stage after the device driver 210, and spool processing may also be performed.

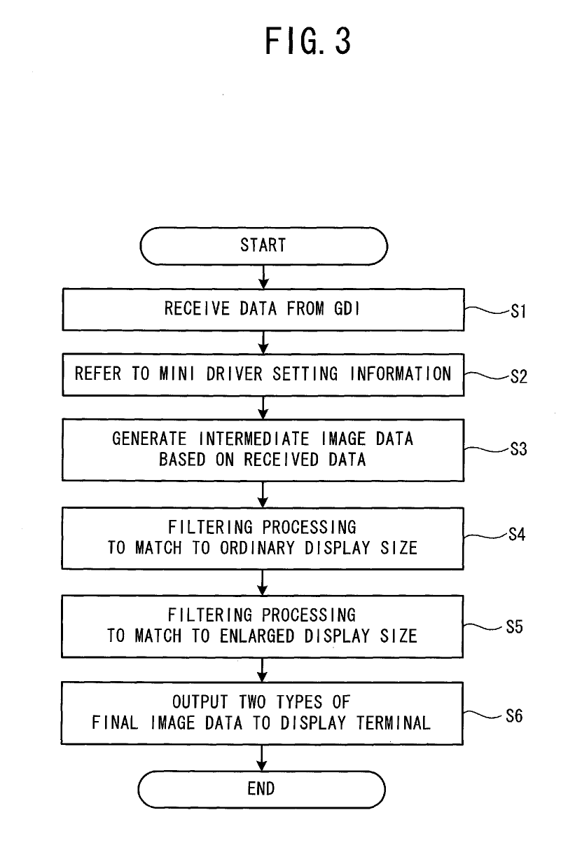

Next, the processing that the device driver 210 causes the CPU 10 to perform will be explained in detail with reference to FIGS. 3 to 8.

As explained previously with reference to FIG. 2, when a request is made in any one of the applications 230 to output text data, image data, or the like, the universal driver 211 receives the request through the GDI 220 (FIG. 3, Step S1). If the data that the universal driver 211 thus receives are text data, the data include code data for characters and coordinate information, and the like, and if the data are image data, the data include source image data, coordinate information, and the like.

As shown in FIG. 3, after the universal driver 211 receives the data, the universal driver 211 refers to the setting information that is stored in the mini driver 212 (Step S2). In the mini driver 212, the output size, the resolution, the number of gray levels, and the like are stored as setting information. In the present embodiment, output size is set to 1,188 vertical pixels and 840 horizontal pixels to match the size of the display screen 21, the resolution is set to 400 dpi, and the number of gray levels is set to 256. As explained previously, the resolution of the display terminal 2 is 100 dpi, and the number of gray levels that the display terminal 2 can display is four (4). In other words, the resolution and the number of gray levels that are stored as the setting information in the mini driver 212 do not match the values for the display terminal 2.

In the present embodiment, anti-aliasing processing is performed using a known oversampling method in order to output to the low-resolution display terminal 2 image data for a high-quality image in which jagged edges are not readily apparent. Specifically, high-resolution image data is generated first, and the image data are then converted into low-resolution image data that are suited to the display terminal 2. The processing that generates the high-resolution image data, which is the front-end processing, is performed by the universal driver 211. Accordingly, the resolution that is higher than the resolution of the display terminal 2 is stored in the mini driver 212. The resolution that is stored in the mini driver 212 is an integer multiple (4 in the present embodiment) of the resolution of the display terminal 2. Thus a conversion of the resolution that does not distort the image can easily be performed by processing the image data using the integer multiple as the conversion ratio for the resolution.

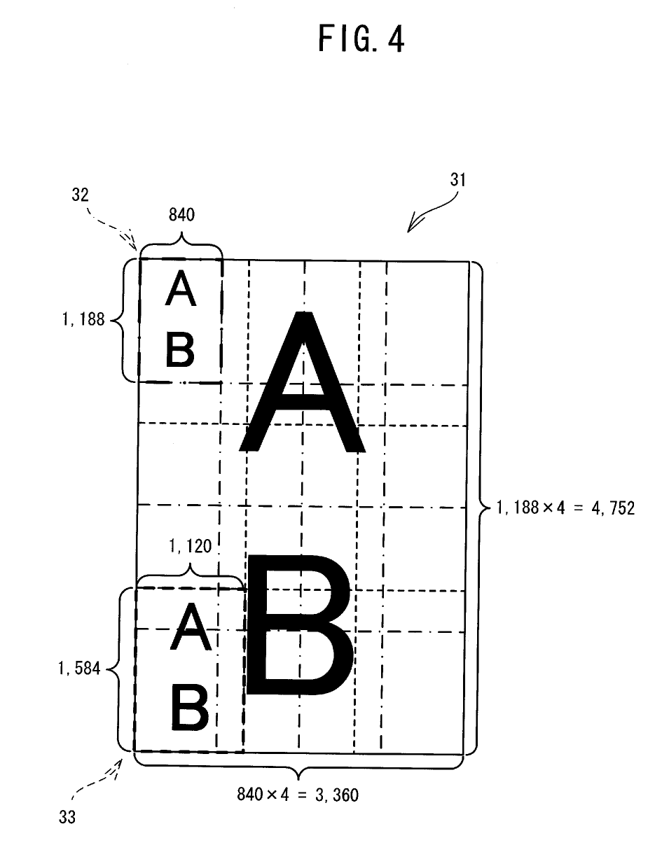

The universal driver 211 performs rendering processing that generates the intermediate image data based on the received data, in accordance with the setting information that is stored in the mini driver 212 (Step S3). The resolution at which the image will actually be displayed later on the display terminal 2 is 100 dpi, but at this stage, the intermediate image data are generated at 400 dpi, which is four times the resolution of the display terminal 2. To explain the process in greater detail, the rendering is performed by taking each individual pixel of the 1,188 vertical pixels and 840 horizontal pixels that match the size of the display screen 21 and dividing it into an array of virtual pixels, with four pixels each in the vertical and horizontal directions. In other words, as shown in FIG. 4, raster image data of an enlarged size with 16 times the number of pixels (4,752 vertical pixels and 3,360 horizontal pixels) are generated as intermediate image data 31.

The intermediate image data 31 that are generated in this manner are output from the universal driver 211 to the filtering processing module 213 (refer to FIG. 2). In the filtering processing module 213, filtering processing is performed that generates the final image data of the ordinary display size by converting the intermediate image data 31 in accordance with the resolution and the number of gray levels of the display terminal 2 (Step S4). The ordinary display size is the 1,188 vertical pixels and 840 horizontal pixels that match the display screen 21.

As described above, the intermediate image data 31 are generated by setting the resolution at the time of the rendering by the universal driver 211 to 400 dpi, that is, four times the 100 dpi resolution of the display terminal 2. Accordingly, if filtering processing is performed that sets the number of the gray levels to four and reduces the resolution to one-fourth of what it was at the time of the rendering, that is, to the 100 dpi that is the resolution of the display terminal 2, final image data 32 of the ordinary display size that is matched to the display terminal 2 (1,188 vertical pixels and 840 horizontal pixels) can be generated based on the intermediate image data 31, as shown in FIG. 4.

Separate filtering processing is also performed in the filtering processing module 213 that generates the final image data for the enlarged display size by converting the intermediate image data 31 in accordance with the setting information for the display terminal 2 (Step S5). In the present embodiment, a fixed size is used for the enlarged display size. Specifically, an enlarged display size of 1,584 vertical pixels and 1,120 horizontal pixels is used, which is vertically and horizontally four-thirds of the ordinary display size (1,188 vertical pixels and 840 horizontal pixels).

As described above, the intermediate image data 31 are generated by taking each individual pixel of the 1,188 vertical pixels and 840 horizontal pixels that match the ordinary display size of the display screen 21 and dividing it into sixteen virtual pixels. Accordingly, if filtering processing is performed that sets the number of the gray levels to four and reduces the number of pixels to one-ninth of what it was, final image data 33 of the enlarged display size (1,584 vertical pixels and 1,120 horizontal pixels) can be generated based on the intermediate image data 31, as shown in FIG. 4. In other words, the generating of the final image data 33 of the enlarged display size is equivalent to converting the 400 dpi resolution, which has been used at the time of the rendering, to one-third of that resolution.

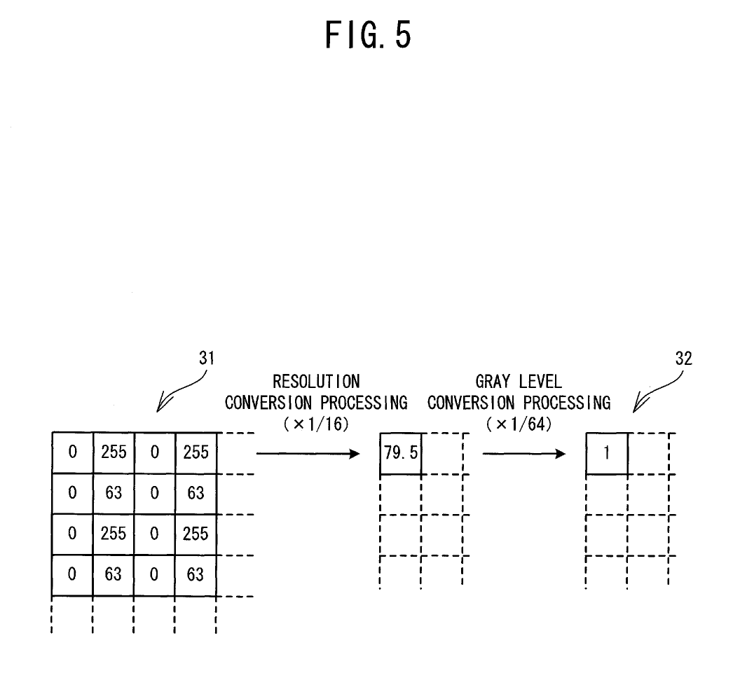

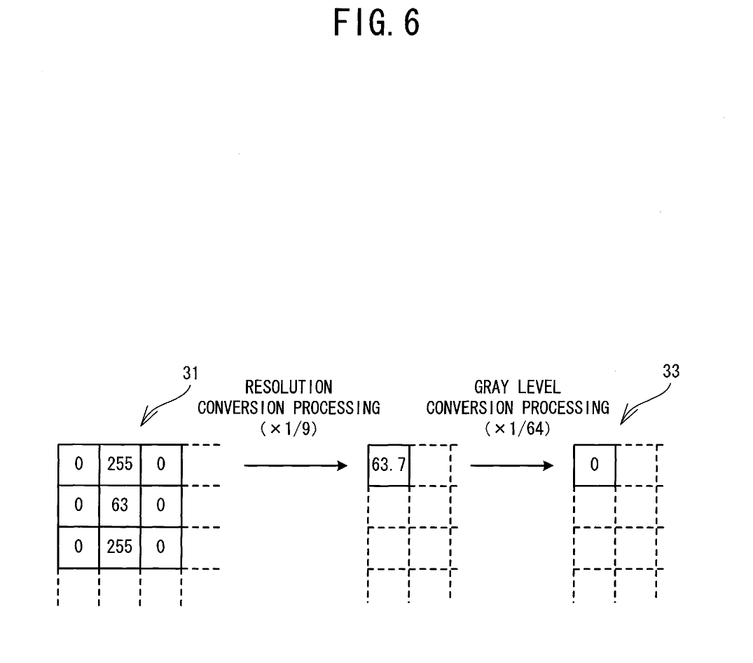

Hereinafter, a specific example of a case in which the two sizes of the final image data 32 and 33 are generated by converting the resolution and converting the gray levels of the intermediate image data 31 through the processing at Steps S4 and S5 described above will be explained with reference to FIGS. 5 and 6.

At Step S4, where the final image data 32 of the ordinary display size is generated, the number of pixels in the intermediate image data 31 is reduced to one-sixteenth of the original size by using the resolution that is one-fourth of the resolution that has been used at the time of the rendering. In other words, groups of sixteen virtual pixels in the intermediate image data 31, four each in the vertical and horizontal directions, are each converted into one pixel. Furthermore, each pixel in the intermediate image data 31 can express one of 256 gray levels, from 0 to 255, but after the conversion, only four gray levels can be expressed.

The example that is shown in FIG. 5 shows a group of sixteen pixels that is located in the upper left corner of the intermediate image data 31 and includes four pixels with a gray level of 255, four pixels with a gray level of 63, and eight pixels with a gray level of 0. First, resolution conversion processing converts the group of sixteen pixels into one pixel that has an averaged gray level of 79.5. Next, gray level conversion processing converts the gray level of 79.5 to 1, in accordance with the four gray levels of the display terminal 2. The final image data 32 for the ordinary display size are generated by performing the same sort of processing for all of the virtual pixels that are included in the intermediate image data 31.

On the other hand, at Step S5, where the final image data 33 of the enlarged display size is generated, the number of pixels in the intermediate image data 31 is reduced to one-ninth of the original size by using the resolution that is one-third of the resolution that has been used at the time of the rendering. In other words, the groups of nine virtual pixels in the intermediate image data 31, three each in the vertical and horizontal directions, are each converted into one pixel. Furthermore, as described above, the 256 gray levels in the intermediate image data 31 are converted to the four gray levels.

The example that is shown in FIG. 6 shows a group of nine pixels that is located in the upper left corner of the intermediate image data 31 and includes two pixels with a gray level of 255, one pixel with a gray level of 63, and six pixels with a gray level of 0. First, the resolution conversion processing converts the group of nine pixels into one pixel that has an averaged gray level of 63.7. Next, the gray level conversion processing converts the gray level of 63.7 to 0, in accordance with the four gray levels of the display terminal 2. The final image data 33 for the enlarged display size are generated by performing the same sort of processing for all of the virtual pixels that are included in the intermediate image data 31.

The final image data 32 and 33 that are thus generated for the ordinary display size and the enlarged display size at Steps S4 and S5, respectively, are output to the display terminal 2 through the I/O interface 13 and the communication device 18 (refer to FIG. 1) (Step S6). After the final image data 32 and 33 are output, the processing that is shown in FIG. 3 is terminated.

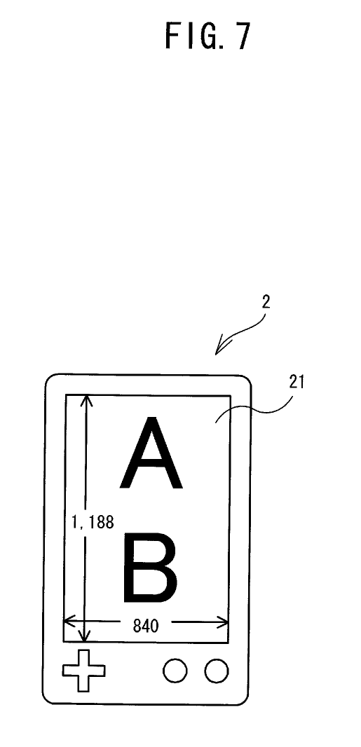

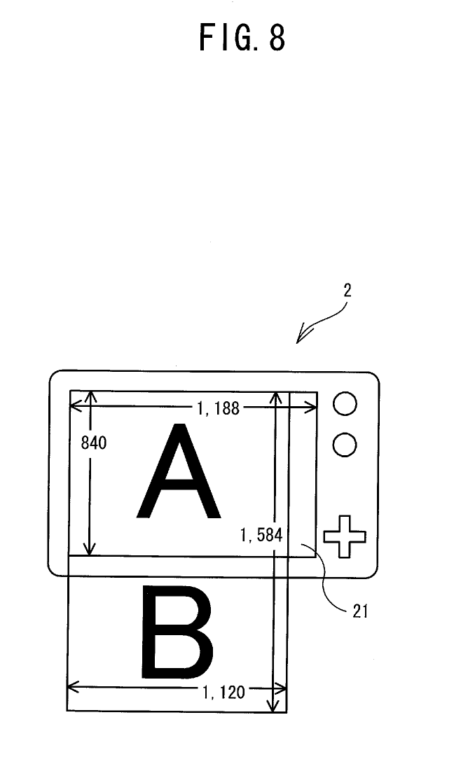

The final image data 32 that are output for the ordinary display size are generated with 1,188 vertical pixels and 840 horizontal pixels in accordance with the size of the display screen 21 of the display terminal 2. Accordingly, on the display terminal 2, an image of the ordinary size can be displayed based on the final image data 32 such that the image fills the entire display screen 21 of display terminal 2, as shown in FIG. 7. In contrast, the final image data 33 for the enlarged display size are generated with 1,584 vertical pixels and 1,120 horizontal pixels, which is four-thirds of the ordinary display size. Accordingly, in a case where an image is displayed based on the final image data 33, as shown in FIG. 8, for example, the enlarged size image can be displayed if the orientation of the display terminal 2 is rotated ninety degrees and the image is divided into upper and lower halves.

In the present embodiment, in order to make it possible for the ordinary size image to be displayed such that the image fills the entire display screen 21 with the display terminal 2 in its normal orientation and for the enlarged size image to be displayed by being divided into upper and lower halves with the orientation of the display terminal 2 being rotated ninety degrees, the enlargement ratio when the intermediate image data 31 are generated and the reduction ratios when the intermediate image data 31 are converted into the final image data 32 and 33 are determined in advance based on the aspect ratio of the display screen 21. Specifically, the ratio of the 1,188 pixels in the vertical direction and the 840 pixels in the horizontal direction of the display screen 21 is approximated by a ratio of two integers, of which at least one integer is a single digit, and the larger of the two integers is defined as N, while the smaller of the two integers is defined as M. In the approximation, values are computed for integer ratios that use the integers 1 to 20 and the integers 1 to 9, and the values are compared to the value of the vertical-to-horizontal ratio of the display screen 21. The integer ratio whose value corresponds most closely to the vertical-to-horizontal ratio of the display screen 21 may be selected.

The integer N that is thus derived is used for the resolution when the intermediate image data 31 are generated and for the resolution when the final image data 32 for the ordinary display size are generated. The integer M is used for the resolution when the final image data 33 for the enlarged display size are generated. Specifically, the resolution that is computed by multiplying the integer N times the resolution of the display terminal 2 is stored in the mini driver 212 as the resolution at the time of the rendering. The resolution of the display terminal 2 (that is, the resolution at the time of the rendering multiplied by 1/N) and the reduction ratio that corresponds to the resolution that is computed by multiplying N/M times the resolution of the display terminal 2 (the resolution at the time of the rendering multiplied by 1/M) are each stored as setting values in the filtering processing module 213.

In the case of the present embodiment, the value of the vertical-to-horizontal ratio of the display screen 21 is approximately 1.4142, and the value of the integer ratio 4:3, approximately 1.3333, is the closest. Accordingly, N is set to 4, and M is set to 3. Then, when the intermediate image data 31 are generated at Step S3, the resolution that is stored in the mini driver 212 (400 dpi), which is four times the resolution of the display terminal 2 (100 dpi), is used to generate the intermediate image data 31 with sixteen times (four times four) the number of pixels for the ordinary display size.

Next, the final image data 32 and 33 for the ordinary display size and the enlarged display size are generated by multiplying the number of pixels in the intermediate image data 31 by one-sixteenth (one-fourth times one-fourth) and one-ninth (one-third times one-third), respectively, in accordance with the setting values that are stored in the filtering processing module 213. Setting the enlargement ratio for generating the intermediate image data 31 and setting the reduction ratios for generating the final image data 32 and 33 based on the aspect ratio of the display screen 21 thus makes it possible to display the enlarged image while utilizing the display screen 21 efficiently.

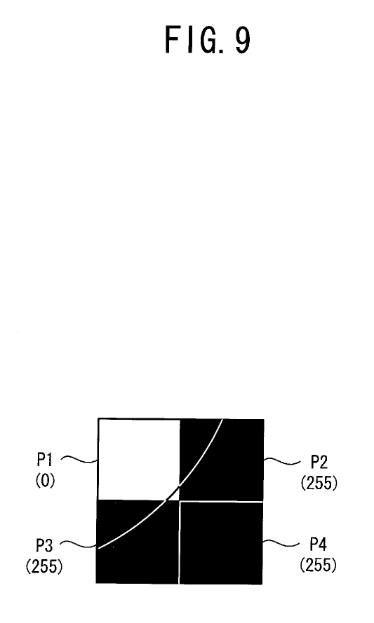

Hereinafter, the effect of using the processing in the present embodiment to reduce jagged edges will be explained with reference to FIGS. 9 to 11, using, as an example, a case in which the final image data 32 for the ordinary display size are generated based on text data. In FIGS. 9 to 11, the reference numerals P1 to P4 each correspond to one of the pixels that configure the display screen 21 of the display terminal 2.

Image data that are generated from character code data by the ordinary rendering processing that uses only the current universal driver 211 are data with only two tones that are expressed by the gray levels 0 and 255, even if there are 256 gray levels in the setting information. Accordingly, when an image is displayed based on these data, a diagonal curvilinear portion that is present in a part of a character, as shown in FIG. 9, appears as a stepped shape in two tones (black and white in FIG. 9). Thus, the lower the resolution at which the character is displayed, the more obvious the jagged edge becomes.

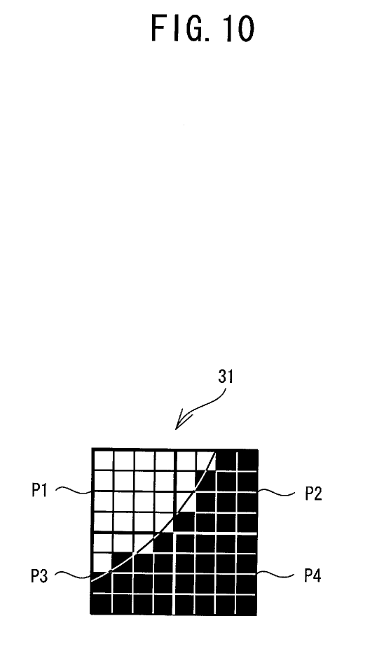

It is assumed that FIG. 9 shows an image that has been produced as a result of the rendering processing at 100 dpi, which is the resolution of the display terminal 2. In contrast, in the case where the rendering processing at Step S3 in FIG. 3 is performed at 400 dpi, which is four times the resolution of the display terminal 2, each of the pixels P1 to P4 in FIG. 9 is multiplied by four in both the vertical and horizontal directions, that is, is divided into sixteen virtual pixels, as shown in FIG. 10. Then the intermediate image data 31 are produced, in which each of the pixels is expressed in one of two tones. This makes the jaggedness of the stepped shape smaller than that shown in FIG. 9.

Next, when the final image data 32 for the ordinary display size are generated in the filtering processing at Step S4 in FIG. 3, the number of pixels is reduced to one-sixteenth the number of pixels in the intermediate image data 31 to match the 100 dpi that is the resolution of the display terminal 2, and the gray levels are converted into four gray levels to match the four gray levels of the display terminal 2. Specifically, the gray levels of each group of sixteen virtual pixels that make up the individual pixels P1 to P4 are averaged and the sixteen pixels are converted into a single pixel that has data specifying one of the four gray levels from 0 to 3.

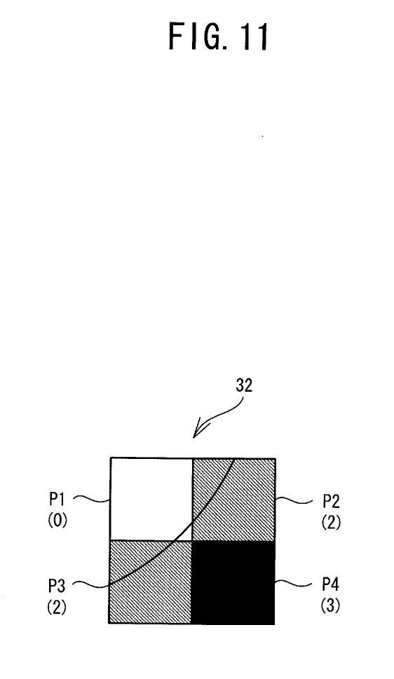

The result, as shown in FIG. 11, is that the pixels P2 and P 3 where the curvilinear portion is located can be expressed by the intermediate gray level 2, for example, such that a smooth final image is produced in which the jagged edge is not so readily apparent. Note that only the processing for the final image data 32 for the ordinary display size has been explained, but even in the case of the final image data 33 for the enlarged display size, the resolution of the intermediate image data 31 is greater than the resolution of the final image data 33 for the enlarged display size. The same sort of effect of making the jagged edge not so readily apparent is therefore also achieved in the final image data 33 for the enlarged display size.

As explained above, according to the device driver 210 of the present embodiment, first the universal driver 211 generates the intermediate image data 31 with a resolution that is higher than that of the display terminal 2. Then the filtering processing module 213 generates the final image data 32 for the ordinary display size and the final image data 33 for the enlarged display size by converting the resolution and the gray levels of the intermediate image data 31 to match those of the display terminal 2 and outputs the final image data 32 and 33 to the display terminal 2. This makes it possible to output image data that yield higher-quality images than in a case where low-resolution image data that match the display terminal 2 are generated right from the start, using only the universal driver 211. Furthermore, this sort of processing can be achieved with a simple configuration that adds the mini driver 212 and the filtering processing module 213 to the universal driver 211 that is provided by the OS 200, the mini driver 212 setting the resolution that is higher than that of the display terminal 2 and the filtering processing module 213 converting the intermediate image data 31 into final image data 32 and 33 for the ordinary display size and the enlarged display size that are suited to the display terminal 2.

Furthermore, in the processing that is performed in order to produce the final image data 32 for the ordinary display size and the final image data 33 for the enlarged display size, the processing is the same up to the point where the intermediate image data 31 are produced by the universal driver 211. In other words, the processing that generates the intermediate image data 31 at the high resolution does have to be performed twice, once for the ordinary display size and once for the enlarged display size. Therefore, the final image data 32 and 33 for the two display sizes can be generated more efficiently.

The configuration that is shown in the embodiment that has been explained above is merely an example, and it is obvious that various types of modifications can be made. For example, in the embodiment that is explained above, the values of the integer N and the integer M are determined based on the aspect ratio of the display screen 21 of the display terminal 2, and the enlargement ratio for generating the intermediate image data 31 and the reduction ratios for generating the final image data 32 and 33 are set accordingly. In this case, one advantage is that it is possible to display the enlarged image, divided into upper and lower halves, when the display terminal 2 is rotated ninety degrees into a horizontal orientation. However, the values of the integer N and the integer M for setting the enlargement ratio for generating the intermediate image data 31 and the reduction ratios for generating the final image data 32 and 33 do not necessarily have to be determined based on the aspect ratio of the display screen 21. In a case where the values of the integer N and the integer M are determined irrespective of the aspect ratio of the display screen 21, the integer N can be set to 6 and the integer M can be set to 3, for example. In this case, the final image data 33 for the enlarged display size is twice (6/3) the size of the final image data 32 for the ordinary display size in both the vertical and horizontal directions, so the enlarged image can be displayed by dividing it into four parts.

In the embodiment that has been explained above, an example was explained in which the final image data 32 for the ordinary display size and the final image data 33 for the enlarged display size are generate. Alternatively, final image data 32 for the ordinary display size and final image data 33 for a reduced display size may also be generated. In that case, the values of the integer N and the integer M that were explained in the embodiment above may be determined such that t the condition that M is greater than N (M>N) is satisfied.

In a case where the final image data 33 are output for the enlarged display size as a size other than the ordinary display size, as in the embodiment that is explained above, it is necessary for the values of the integer N and the integer M to be such that M is less than N (M<N). In a case where M is less than N, M is not less than 2, and N is not less than 3, the resolution of the final image data 33 for the enlarged display size is always higher than the resolution that is used at the time when the intermediate image data 31 are rendered. In other words, the final image data 33 for the enlarged display size is also generated by the anti-aliasing processing. Therefore, both the ordinary size image and the enlarged size image can be smooth, high-quality images in which the jagged edges are not readily apparent.

On the other hand, in a case where M is less than N (M<N) and M is 1 (M=1), the resolution of the final image data 33 for the enlarged display size is equal to the resolution that is used at the time when the intermediate image data 31 are rendered. Accordingly there is little effect of reducing the jaggedness of the enlarged size image. However, in this case, the final image data 33 for the enlarged display size has the same resolution as the intermediate image data 31, while the number of gray levels is matched to the display terminal 2 This provides an advantage in a case where the final image data 33 for the enlarged display size is edited later on the PC 1. Specifically, it makes it possible to easily generate an edited version of the final image data for the ordinary display size by converting the resolution of the edited final image data 33 for the enlarged display size, in the same manner in which the final image data 32 for the ordinary display size are generated from the intermediate image data 31 at Step S4 in FIG. 3.

For both the enlarged image and the reduced image, the quality of the ordinary size image that is finally produced becomes better as the value of the integer N that determines the resolution when the intermediate image data 31 are generated is increased, but the speed of the rendering processing by the universal driver 211 becomes slower. Accordingly, it is preferable for the values of the integer N and the integer M to be demonstrated in consideration of the allowable processing speed. From this viewpoint, it is preferable for at least one of the integer N and the integer M to be a single digit. It is even more desirable for both of the integers to be single digits.

The integers N and M do not necessarily have to be single fixed values. The user may select desired values instead, on a case-by-case basis from a plurality of candidates that have been prepared in advance, taking into account the image quality and the processing speed. For example, the value of N can be selected from among the three candidates 2, 4, 8. The values of the integers N and M may be selected from a setting screen that is displayed by a user interface (not shown in the drawings) of the device driver 210. The user interface would be created by the developer of the display terminal 2, as in the case of the mini driver 212 and the filtering processing module 213. In this case, the resolution to be used at the time of the rendering of the intermediate image data 31 would be set based on the selected integer N and be stored in the mini driver 212. The resolutions of the final image data 32 and 33 for the ordinary display size and the enlarged display size would be set in the filtering processing module 213, based on the selected integers N and M.

In the embodiment that is explained above, the number of pixels on the display screen 21 of the display terminal 2 is 1,188 pixels in the vertical direction and 840 pixels in the horizontal direction. In other words, the number of pixels in each direction is a multiple of the integer M (3) that is used for the reduction ratio (the resolution at the time of the rendering multiplied by 1/M) that is used when the intermediate image data 31 are converted into the final image data 33 for the enlarged display size. Accordingly, the size of the intermediate image data 31 that are generated based on this size is also a multiple of the integer M (3). Therefore, it is not necessary to perform the fraction processing at Step S5 in FIG. 3, so the processing can be performed more simply and efficiently.

Thus, by defining a divisor of the number of pixels in the vertical direction and the and horizontal direction of the intermediate image data 31 as the integer M, the fraction processing can be made unnecessary, no matter what the value of the integer N that determines the resolution when the intermediate image data 31 are generated. Alternatively, if the resolution that is used at the time of the rendering that generates the intermediate image data 31 is defined as (N×M) times the resolution of the display terminal 2, regardless of the number of pixels in the vertical direction and the horizontal direction of the display screen 21, the fraction processing can be made unnecessary for converting the intermediate image data 31 into the final image data 33 for the enlarged display size. However, although it is desirable from the standpoint of processing efficiency not to perform the fraction processing, it is still possible to perform the fraction processing, so it is not absolutely necessary for the integer M to be the divisor of the number of pixels in the vertical direction and in the horizontal direction of the intermediate image data 31.

In the embodiment that is explained above, an example was explained in which the image data are output to the display terminal 2, which is an image forming device, but the output destination for the image data may also be a printer, which is another example of an image forming device. Even in that case, in the same manner as in the embodiment that is explained above, the processing may be performed that generates the intermediate image data at a resolution that is higher than that of the printer, then converts the intermediate image data into the two sets of final image data, one for a set paper size and the other for an enlarged size, in accordance with the resolution and the number of gray levels of the printer.

While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. A non-transitory computer-readable medium disclosed herein includes all forms of software and hardware, with the exception of purely transitory media, i.e., signals. It is intended that the specification and the described examples are illustrative with the true scope of the invention being defined by the following claims.

What is claimed is:

1. A non-transitory computer-readable medium that stores a device driver, the device driver comprising:
a universal driver that is provided by a general-purpose operating system and that includes instructions that cause a computer to perform the steps of:
acquiring graphic data that serve as a basis for output image data for an image forming device to form an image; and
generating first image data based on the acquired graphic data;
a mini driver that includes, as a first resolution to be used when the first image data are generated, a resolution that is computed by multiplying a second resolution by an integer N that is not less than 2, the second resolution being a resolution that corresponds to an image that can be formed by the image forming device; and
a filtering processing module that includes the second resolution, a number of gray levels that can be expressed by the image forming device, and instructions that cause a computer to perform the steps of:
converting the first image data that have been generated at the first resolution into second image data, based on the second resolution and the number of gray levels;
converting the first image data that have been generated at the first resolution into third image data, based on the number of gray levels and on a third resolution that is computed by dividing the first resolution by an integer M; and
outputting the second image data and the third image data that have been obtained through conversion as the output image data to the image forming device.

2. The non-transitory computer-readable medium according to claim 1, wherein
the first resolution is computed by multiplying the second resolution by a number that is a product of the integer N and the integer M (N×M).

3. The non-transitory computer-readable medium according to claim 1, wherein
the integer N is an integer that is not less than 3, and
the integer M is an integer that is less than the integer N and is not less than 2.

4. The non-transitory computer-readable medium according to claim 3, wherein
the integer N and the integer M are respectively the greater and the lesser of two integers, at least one of which is a single digit and the ratio of which approximates a vertical-to-horizontal ratio of the image that can be formed by the image forming device.

5. The non-transitory computer-readable medium according to claim 1, wherein
the integer M is 1.
